(19) United States
(12) Patent Application Publication
(10) Pub. No.: US 2026/0343104 A1
(43) Pub. Date: Oct. 29, 2026

(54) BIDIRECTIONAL SLAB PLACEMENT FOR BACKSCATTER LIGHTING CALCULATION

(71) Applicant: Battelle Memorial Institute, Columbus, OH (US)

(72) Inventors: Noah CHARLTON, Newark, OH (US); Michael HAGERMAN, Lewis Center, OH (US)

(21) Appl. No.: 19/533,465

(22) Filed: Feb. 9, 2026

Related U.S. Application Data
(60) Provisional application No. 63/758,384, filed on Feb. 14, 2025.

(51) Int. Cl. H04N 23/75; H04N 23/695; H04N 23/74

(52) U.S. Cl. CPC H04N 23/75; H04N 23/695; H04N 23/74

(57) ABSTRACT

In an approach to bidirectional slab placement for backscatter lighting calculation a system includes one or more computer processors, an image source, and program instructions stored on a non-transitory storage device for execution by at least one of the one or more computer processors. The stored program instructions including instructions to determine a distance from a camera to one or more light sources in a scene, group any of the one or more light sources whose distance to the camera differs by less than a predetermined distance, place one or more slabs near each group of the one or more light sources and fill one or more remaining gaps between the one or more slabs by placing additional slabs starting at the camera and moving progressively further away.

### CROSS-REFERENCE TO RELATED APPLICATIONS

The present application claims the benefit of the filing date of U.S. Provisional Application Ser. No. 63/758,384, filed Feb. 14, 2025, the entire teachings of which application is hereby incorporated herein by reference.

### TECHNICAL FIELD

The present disclosure relates generally to simulating underwater images and, more particularly, to a system and method for bidirectional slab placement for backscatter lighting calculation.

### BACKGROUND

In photography, backscatter is an optical phenomenon resulting in artifacts on an image caused by light sources being reflected from particles in the air or water. Modeling the backscattering of light is required for simulating underwater images. Current models for the backscattering of light are computationally expensive. There exists a need for more efficient models for the backscattering of light for simulating underwater images.

### BRIEF DESCRIPTION OF THE DRAWINGS

Reference should be made to the following detailed description which should be read in conjunction with the following figures, wherein like numerals represent like parts.

FIG. 1 is an example of dividing a scene into slabs, consistent with the present disclosure.

FIG. 2 is a graph illustrating the brightness of a light source versus distance in a comparison of two algorithms.

FIGS. 3A-3D illustrate the steps for one illustrative example embodiment of the method for bidirectional slab placement for backscatter lighting calculation consistent with the present disclosure.

FIG. 4 is a functional block diagram illustrating a distributed data processing environment for bidirectional slab placement for backscatter lighting calculation consistent with the present disclosure.

FIG. 5 is a flowchart diagram depicting a process for bidirectional slab placement for backscatter lighting calculation, on the distributed data processing environment of FIG. 1, consistent with the present disclosure.

FIG. 6 depicts a block diagram of components of the computing device executing the process of FIG. 6 within the distributed data processing environment of FIG. 4, consistent with the present disclosure.

### DETAILED DESCRIPTION

Disclosed herein is a system and method for dynamically dividing a scene into slabs for smoothly modeling backscattered light in underwater environments.

Applications for the disclosed system and method may include, but are not limited to, underwater Light Detection and Ranging (LIDAR), to provide simulated environment video feeds in support of pilot underwater remotely operated vehicle (ROV) training, for example, for inspection and maintenance operations in the oil and gas industry, without having to put an actual ROV in the water, for the generation of video samples with variable levels of visibility for use in the development, training and testing of underwater vision systems, and for ROV docking systems, for example, for computer vision based docking. In the last example, an ROV may be configured to visually locate and track a known docking pattern or dock feature on an underwater object and then dock with the object.

Modeling the backscattering of light is required for simulating underwater images but current model implementations are computationally expensive. One such model is the Jaffe-McGlamery (1990) model. The Jaffe-McGlamery model divides a scene into slabs which are used for calculating the backscattered light for a certain pixel in the image. Each slab is a box that is infinitely wide and tall but finitely thick in the viewing axis of the camera. Slabs are placed parallel to the camera's visible frame.

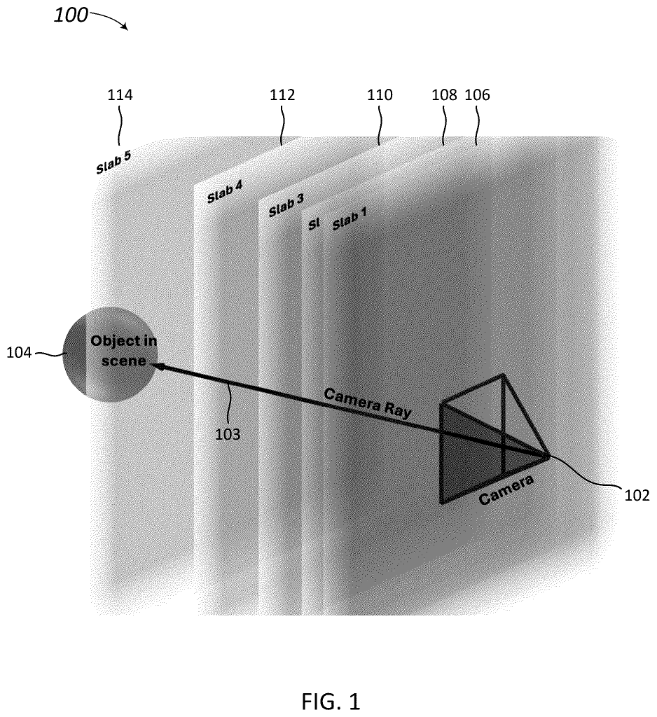

A depiction of these slabs is shown in FIG. 1. The scene 100 depicts a camera 102 that is focused on an object 104 along a camera ray 103 that projects from the center of the camera 102. The scene 100 is divided into a series of five slabs, a slab-1 106, a slab-2 108, a slab-3 110, a slab-4 112, and a slab-5 114.

The backscatter component of each pixel is made up of the accumulation of the backscatter for each slab in front of the object the pixel is rendering. The placement of the slabs has a significant effect on the resulting backscatter component.

When using the Jaffe-McGlamery model, slab placement has a large effect on the strength of the backscatter component. The easiest way to produce an accurate image is to use many thin slabs. However, this method is computationally expensive which limits use in producing real-time imagery.

Another technique called “adaptive slab thickness sampling” (Song et al., 2021) arranges slabs that start thin near the camera and grow exponentially thick as the distance increases. This algorithm works well when the light sources have fixed position relative to the camera (e.g., headlights on an ROV) but produces shimmering artifacts when the light sources move within the camera's field of view. The shimmering occurs because as the slabs move position relative to the light source, the brightness calculation changes as slabs near the light move closer and further away. To avoid this issue, the disclosed system places the slabs around the light sources first which makes the slabs have constant position relative to the light sources. This results in images with smooth brightness changes over a large range of distances while keeping the number of slabs to a relatively small number. It is also more efficient, because small slabs are focused on light sources where backscattering is most significant and large slabs are in places where the brightness is relatively constant.

The disclosed system and method determines the position and size of the slabs using the geometry of the lights within the scene. In an embodiment, the distance from the camera to each light source is determined in the direction the camera is looking. Next, lights whose distance to the camera differed by less than 0.05 meters are grouped into one light source at the position of the closest light source to the camera. Slabs are placed near each group of light sources. Finally, the remaining gaps are filled by placing slabs starting at the camera and moving progressively further away until all gaps are filled.

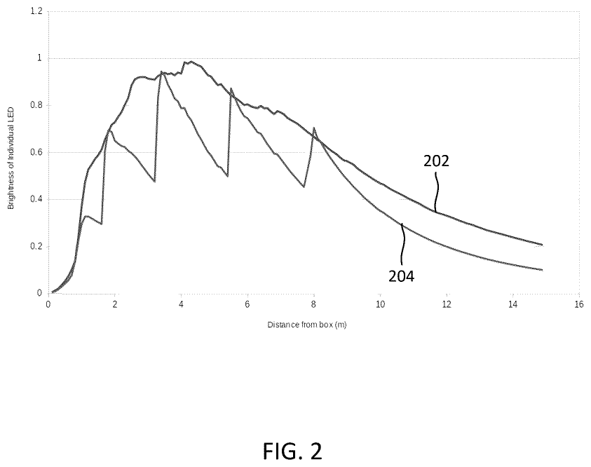

FIG. 2 is a graph illustrating the brightness of a light source versus distance in a comparison of the Song et al. algorithm to the disclosed method. In FIG. 2 the disclosed method is shown in line 202 and the Song et al. algorithm is shown in line 204. The graph shows the brightness of an individual light-emitting diode (LED) on the y-axis versus the distance from the light source on the x-axis. This graph was created from a simulated scene modeling a grid of lights. For this simulation, a commercial light box was used as the light source. Each line represents the average brightness of 64×64 pixel area around a single light from the grid as the camera moves further away from the light box. The brightness was recorded by averaging the R, G, and B channels from the image produced by the disclosed method. Each channel is in the range [0, 1], so the maximum brightness would be 1.0. As shown, the disclosed method in line 202 is a smooth curve, while the Song et al. algorithm in line 204 is choppy with many local peaks and valleys.

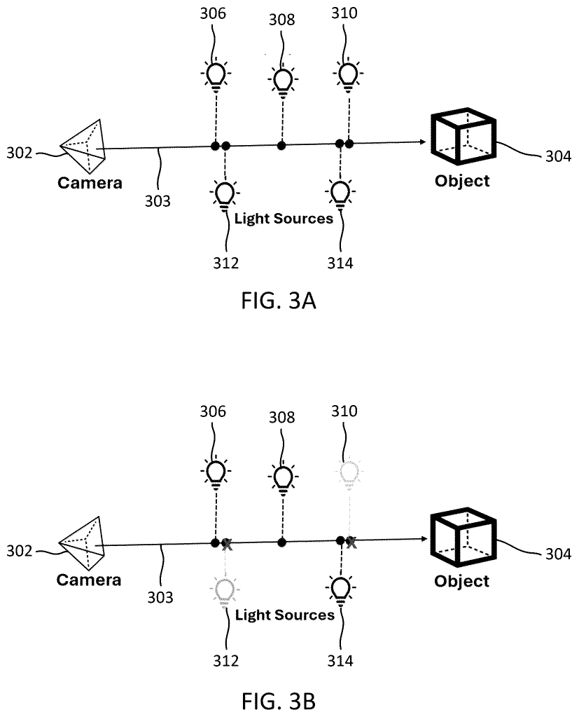

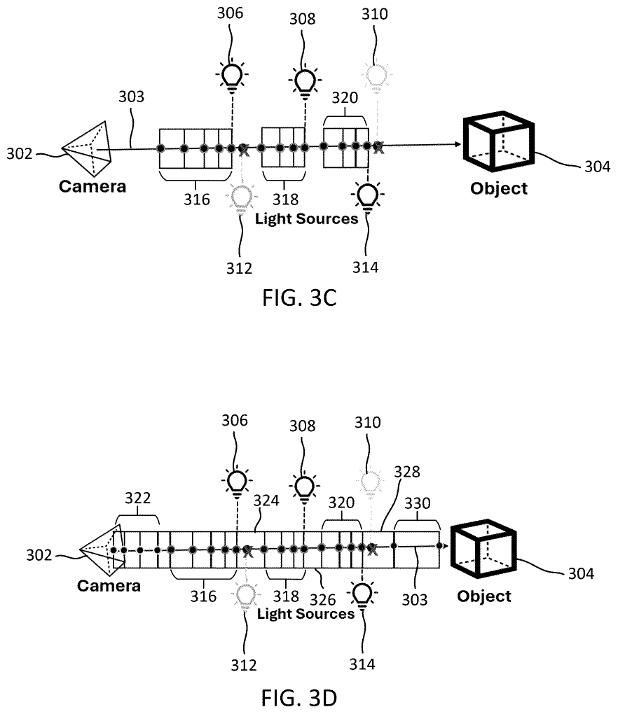

FIGS. 3A-3D illustrate the steps for one illustrative example embodiment of the method for bidirectional slab placement for backscatter lighting calculation consistent with the present disclosure. In the example steps of FIGS. 3A-3D, a camera 302 is directed at an object 304 along center ray 303. This example has five light sources along the ray 303. They are light source-1 306, light source-2 308, light source-3 310, light source-4 312, and light source-5 314. It should be noted that other examples may have fewer or more light sources than the example of FIGS. 3A-3D. The first step is to determine the distance from the camera to each light source in the direction the camera is looking. This is determined by casting the ray 303 out from the center of the camera and finding the closest point, or projection, on the ray 303 for each light source.

Next, lights that are a similar distance from the camera are grouped and those with similar projections are removed. In FIG. 3B, light source-3 310 has been removed due to a similar projection to light source-5 314 and light source-4 312 has been removed due to a similar projection to light source-1 306. In some embodiments, lights whose distance to the camera differed by less than 0.05 meters may be grouped into one light source at the position of the closest light source to the camera. In some other embodiments, lights whose distance to the camera differed by a user selected distance may be grouped into one light source at the position of the closest light source to the camera.

The next step is to backfill slabs from each remaining light source. For each remaining light source, slabs are placed starting from the light source sequentially towards the camera, with each of the slabs progressively thicker than the adjacent previous slab. In FIG. 3C, slabs 316 have been placed between light source-1 306 and the camera 302, slabs 318 have been placed between light source-2 308 and the camera 302, and slabs 320 have been placed between light source-5 314 and the camera 302.

In an embodiment, the slab thickness for each slab is determined by Formula (1),

$$Δ {z}_{i} = 2.2 * \frac{{d}_{ma x}}{{e}^{N}} * \frac{{N}^{i - 1}}{( i - 1 ) !} \qquad ( 1 )$$

where dₘₐₓ is the maximum depth of the scene, N is the number of slabs, and Δzᵢ is the thickness of the i'th slab within the group of slabs. It should be noted that Formula (1) is from Song et. al (2021). The slab closest to each light source will be the size of an i=0 slab. The next will be size of the slab where i=1. In FIG. 3C, the right-most slab of slabs 316 will have size Δz₀, and the left-most slab will have size Δz₃. The right-most slab of slabs 318 will have size Δz₀ and the left-most slab will have size Δz₂.

In an embodiment, slabs are placed until the start of a slab being placed is within 1 meter of a light source or camera. For example, an example, consider FIG. 3C. For light source 306, it will start backfilling, but once the slabs are within 1 meter of the camera it will stop. For light source 308, it will start backfilling until the start of the next slab to be placed is within 1 meter of light source 306. The choice of 1 meter was arbitrary and could be configured by the user.

Finally, the remaining gaps are filled by placing slabs starting at the camera and getting progressively further away. This is important to account for any light sources that could be mounted behind the camera (for example, on a theoretical ROV). The slabs become gradually thicker as the distance to the camera increases, as described above. In FIG. 3D, slabs 322, slabs 324, slabs 326, slabs 328, and slabs 330 have been added to fill all remaining gaps. In an embodiment, the slab thickness for each slab is determined by Formula (1) above. The slab closest to the camera will have a thickness of an i=0 slab. The next slab will be placed with size i=1. In FIG. 3D, the left-most slab of slabs 322 will have size Δz₀ and the right-most slab will have size Δz₃. Slabs will keep being placed until the maximum depth chosen by the user is reached. For example, a user may choose to use 20.0 meters the maximum depth. It should be noted, however, that higher numbers result in lower performance due to having to render more slabs.

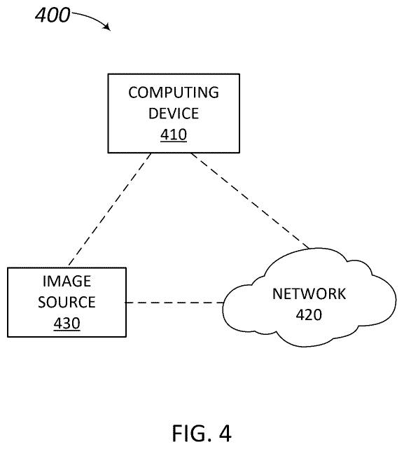

FIG. 4 is a functional block diagram illustrating a distributed data processing environment, generally designated 400, suitable for bidirectional slab placement for backscatter lighting calculation consistent with the present disclosure. The term “distributed” as used herein describes a computer system that includes multiple, physically distinct devices that operate together as a single computer system. FIG. 4 provides only an illustration of one implementation and does not imply any limitations with regard to the environments in which different embodiments may be implemented. Many modifications to the depicted environment may be made by those skilled in the art without departing from the scope of the disclosure as recited by the claims.

Distributed data processing environment 400 includes computing device 410 optionally connected to network 420. Network 420 can be, for example, a telecommunications network, a local area network (LAN), a wide area network (WAN), such as the Internet, or a combination of the three, and can include wired, wireless, or fiber optic connections. In general, network 420 can be any combination of connections and protocols that will support communications between computing device 410 and other computing devices (not shown) within distributed data processing environment 400.

In an embodiment, computing device 410 can be a standalone computing device, a management server, a web server, a mobile computing device, or any other electronic device or computing system capable of receiving, sending, and processing data. In another embodiment, computing device 410 can represent a server computing system utilizing multiple computers as a server system, such as in a cloud computing environment. In yet another embodiment, computing device 410 represents a computing system utilizing clustered computers and components (e.g., database server computers, application server computers) that act as a single pool of seamless resources when accessed within distributed data processing environment 400.

Distributed data processing environment 400 also optionally includes an image source 430. In an embodiment, the image source 430 may be a repository or database of images. In some embodiments, the images contained in the image source 430 may be images captured by a camera or other imaging device. In some other embodiments, the images contained in the image source 430 may be simulated images. In another embodiment, the image source 430 may be a camera or other image capture device.

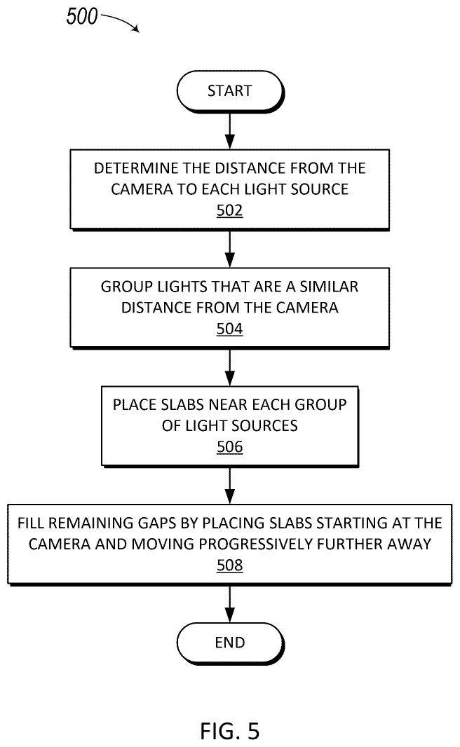

FIG. 5 is a flowchart diagram 500 depicting a process for bidirectional slab placement for backscatter lighting calculation, on the distributed data processing environment of FIG. 4, consistent with the present disclosure. It should be appreciated that embodiments of the present disclosure provide at least for bidirectional slab placement for backscatter lighting calculation. However, FIG. 5 provides only an illustration of one implementation and does not imply any limitations with regard to the environments in which different embodiments may be implemented. Many modifications to the depicted environment may be made by those skilled in the art without departing from the scope of the disclosure as recited by the claims.

The method of FIG. 5 follows the graphical illustration of the process in FIGS. 3A-3D.

Process 500 includes determining the distance from the camera to each light source (operation 502). In the illustrated example embodiment, the first step is to determine the distance from the camera to each light source in a scene in the direction the camera is looking. This is accomplished by casting a ray out from the center of the camera and finding the closest point on the ray for each light source. If the closest point to the ray is behind the camera, the light is ignored.

Process 500 includes grouping lights that are a similar distance from the camera (operation 504). The next step is to group lights that are a similar distance from the camera. This optimization prevents excess slabs from being added for lights that are placed in a plane parallel to the camera. In an embodiment, lights whose distance to the camera differed by less than 0.05 meters are considered a similar distance from the camera and are grouped into one light source at the position of the closest light source to the camera.

Process 500 includes placing slabs near each group of light sources (operation 506). In operation 506, slabs are placed near each group of light sources. For each light source, slabs are placed from the light source towards the camera, with the slabs getting progressively thicker the further from the light source. In an embodiment, the slab thickness for each slab is determined by Formula (1) above. It is important to place many slabs near the light source because the backscatter component will be strongest near the light source.

In an embodiment, slabs are placed until the start of a slab being placed is within 1 meter of a light source or camera. For example, an example, consider FIG. 3C. For light source 306, it will start backfilling, but once the slabs are within 1 meter of the camera it will stop. For light source 308, it will start backfilling until the start of the next slab to be placed is within 1 meter of light source 306. The choice of 1 meter was arbitrary and could be configured by the user.

Process 500 includes filling remaining gaps by placing slabs starting at the camera and moving progressively further away (operation 508). In operation 508, the remaining gaps are filled by placing slabs starting at the camera and getting progressively further away. The slabs gradually become thicker as the distance from the camera increases.

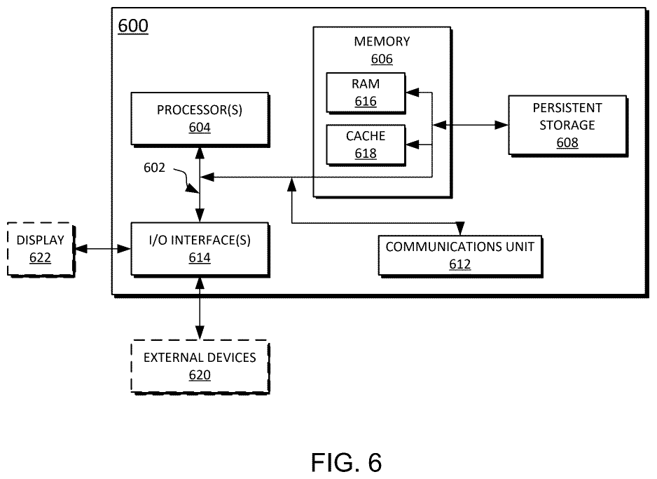

FIG. 6 is a block diagram depicting components of one example of the computing device 410 suitable for bidirectional slab placement for backscatter lighting calculation, within the distributed data processing environment of FIG. 1, consistent with the present disclosure. FIG. 6 displays the computing device or computer 600, one or more processor(s) 604 (including one or more controllers or computer processors), a communications fabric 602, a memory 606 including a random-access memory (RAM) 616 and a cache 618, a persistent storage 608, a communications unit 612, I/O interfaces 614, a display 622, and external devices 620. It should be appreciated that FIG. 6 provides only an illustration of one embodiment and does not imply any limitations with regard to the environments in which different embodiments may be implemented. Many modifications to the depicted environment may be made.

As depicted, the computer 600 operates over the communications fabric 602, which provides communications between the computer processor(s) 604, memory 606, persistent storage 608, communications unit 612, and input/output (I/O) interface(s) 614. The communications fabric 602 may be implemented with an architecture suitable for passing data or control information between the processors 604 (e.g., microprocessors, communications processors, and network processors), the memory 606, the external devices 620, and any other hardware components within a system. For example, the communications fabric 602 may be implemented with one or more buses.

The memory 606 and persistent storage 608 are computer readable storage media. In the depicted embodiment, the memory 606 comprises a RAM 616 and a cache 618. In general, the memory 606 can include any suitable volatile or non-volatile computer readable storage media. Cache 618 is a fast memory that enhances the performance of processor(s) 604 by holding recently accessed data, and near recently accessed data, from RAM 616.

Program instructions for bidirectional slab placement for backscatter lighting calculation may be stored in the persistent storage 608, or more generally, any non-transitory computer readable storage media, for execution by one or more of the respective computer processors 604 via one or more memories of the memory 606. The persistent storage 608 may be a magnetic hard disk drive, a solid-state disk drive, a semiconductor storage device, flash memory, read only memory (ROM), electronically erasable programmable read-only memory (EEPROM), or any other non-transitory computer readable storage media that is capable of storing program instruction or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

The communications unit 612, in these examples, provides for communications with other data processing systems or devices. In these examples, the communications unit 612 includes one or more network interface cards. The communications unit 612 may provide communications through the use of either or both physical and wireless communications links. In the context of some embodiments of the present disclosure, the source of the various input data may be physically remote to the computer 600 such that the input data may be received, and the output similarly transmitted via the communications unit 612.

The I/O interface(s) 614 allows for input and output of data with other devices that may be connected to computer 600. For example, the I/O interface(s) 614 may provide a connection to external device(s) 620 such as a keyboard, a keypad, a touch screen, a microphone, a digital camera, and/or some other suitable input device. External device(s) 620 can also include portable computer readable storage media such as, for example, thumb drives, portable optical or magnetic disks, and memory cards. Software and data used to practice embodiments of the present disclosure can be stored on such portable computer readable storage media and can be loaded onto persistent storage 608 via the I/O interface(s) 614.

I/O interface(s) 614 may also connect to a display 622. Display 622 provides a mechanism to display data to a user and may be, for example, a computer monitor. Display 622 can also function as a touchscreen, such as a display of a tablet computer.

According to one aspect of the disclosure there is thus provided a system for bidirectional slab placement for backscatter lighting calculation. The system includes one or more computer processors, an image source, and program instructions stored on a non-transitory storage device for execution by at least one of the one or more computer processors. The stored program instructions including instructions to determine a distance from a camera to one or more light sources in a scene, group any of the one or more light sources that are a similar distance from the camera, place one or more slabs near each group of the one or more light sources and fill one or more remaining gaps between the one or more slabs by placing additional slabs starting at the camera and moving progressively further away.

According to another aspect of the disclosure, there is provided a computer-implemented method for bidirectional slab placement for backscatter lighting calculation. The method includes determining, by one or more computer processors, a distance from a camera to one or more light sources in a scene, grouping, by the one or more computer processors, any of the one or more light sources that are a similar distance from the camera, placing, by the one or more computer processors, one or more slabs near each group of the one or more light sources, and filling, by the one or more computer processors, one or more remaining gaps between the one or more slabs by placing additional slabs starting at the camera and moving progressively further away.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art. Also, it may be appreciated that the phraseology and terminology used herein is for the purpose of description and should not be regarded as limiting as such may be understood by one of skill in the art. Throughout the present disclosure, like reference characters may indicate like structure throughout the several views, and such structure need not be separately discussed. Furthermore, any particular feature(s) of a particular exemplary embodiment may be equally applied to any other exemplary embodiment(s) of this disclosure as suitable. In other words, features between the various exemplary embodiments described herein are interchangeable, and not exclusive.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

The present disclosure may be a system, a method, and/or a computer program product. The system or computer program product may include one or more non-transitory computer readable storage media having computer readable program instructions thereon for causing a processor to carry out aspects of the present disclosure.

The one or more non-transitory computer readable storage media can be any tangible device that can retain and store instructions for use by an instruction execution device. The one or more non-transitory computer readable storage media may be, for example, but is not limited to, an electronic storage device, a magnetic storage device, an optical storage device, an electromagnetic storage device, a semiconductor storage device, or any suitable combination of the foregoing. A non-transitory computer readable storage media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from one or more non-transitory computer readable storage media or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in one or more non-transitory computer readable storage media within the respective computing/processing device.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some embodiments, electronic circuitry including, for example, programmable logic circuitry, Field-Programmable Gate Arrays (FPGA), or other Programmable Logic Devices (PLD) may execute the computer readable program instructions by utilizing state information of the computer readable program instructions to personalize the electronic circuitry, in order to perform aspects of the present disclosure.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the disclosure. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A system for bidirectional slab placement for backscatter lighting calculation, the system comprising:
one or more computer processors;
an image source; and
program instructions stored on a non-transitory storage device for execution by at least one of the one or more computer processors, the stored program instructions including instructions to:
determine a distance from a camera to one or more light sources in a scene;
group any of the one or more light sources whose distance to the camera differs by less than a predetermined distance;
place one or more slabs near each group of the one or more light sources; and
fill one or more remaining gaps between the one or more slabs by placing additional slabs starting at the camera and moving progressively further away.

2. The system of claim 1, wherein the predetermined distance is less than 0.05 meters.

3. The system of claim 1, wherein the image source is a simulation.

4. The system of claim 1, wherein the image source is a database of one or more scenes.

5. The system of claim 1, wherein determine the distance from the camera to the one or more light sources in the scene further comprises:
casting a ray from a center of the camera; and
finding a closest point on the ray for each of the one or more light sources.

6. The system of claim 1, wherein the one or more light sources are grouped to prevent one or more excess slabs from being added for any of the one or more light sources that are placed in a plane parallel to the camera.

7. The system of claim 1, wherein place the one or more slabs near each group of the one or more light sources further comprises:
placing the one or more slabs from each of the one or more light sources starting from each of the one or more light sources sequentially towards the camera, wherein each of the one or more slabs is progressively thicker than an adjacent previous slab.

8. The system of claim 7, wherein the thickness of each of the one or more slabs is determined from the formula
$$Δ {z}_{i} = 2.2 * \frac{{d}_{m ax}}{{e}^{N}} * \frac{{N}^{i - 1}}{( i - 1 ) !}$$
wherein dmax is a maximum depth of the scene, N is a number of slabs, and Δzi is a thickness of an i'th slab within the group of slabs.

9. The system of claim 8, wherein slabs are placed until the start of a next slab being placed is within one meter of a light source or camera.

10. The system of claim 8, wherein slabs are placed until the start of a next slab being placed is within a user selected distance of a light source or camera.

11. The system of claim 8, wherein:
a first slab is placed starting at the camera, the first slab having a thickness of Δz₀;
one or more additional slabs are placed until a user selected maximum depth is reached, and further wherein:
each of the one or more additional slabs is placed adjacent to a previous slab; and
each of the additional slabs has a thickness of Δzₙ, wherein n is the number of the each additional slab relative to the first slab.

12. A computer-implemented method for bidirectional slab placement for backscatter lighting calculation, the method comprising:
determining, by one or more computer processors, a distance from a camera to one or more light sources in a scene;
grouping, by the one or more computer processors, any of the one or more light sources whose distance to the camera differs by less than a predetermined distance;
placing, by the one or more computer processors, one or more slabs near each group of the one or more light sources; and
filling, by the one or more computer processors, one or more remaining gaps between the one or more slabs by placing additional slabs starting at the camera and moving progressively further away.

13. The computer-implemented method of claim 12, wherein the predetermined distance is less than 0.05 meters.

14. The computer-implemented method of claim 12, wherein determining the distance from the camera to the one or more light sources in the scene further comprises:
casting a ray from a center of the camera; and
finding a closest point on the ray for each of the one or more light sources.

15. The computer-implemented method of claim 12, wherein the one or more light sources are grouped to prevent one or more excess slabs from being added for any of the one or more light sources that are placed in a plane parallel to the camera.

16. The computer-implemented method of claim 12, wherein placing the one or more slabs near each group of the one or more light sources further comprises:
placing the one or more slabs from each of the one or more light sources starting from each of the one or more light sources sequentially towards the camera, wherein each of the one or more slabs is progressively thicker than an adjacent previous slab.

17. The system of claim 16, wherein the thickness of each of the one or more slabs is determined from the formula
$$Δ {z}_{i} = 2.2 * \frac{{d}_{ma x}}{{e}^{N}} * \frac{{N}^{i - 1}}{( i - 1 ) !}$$
wherein dmax is a maximum depth of the scene, N is a number of slabs, and Δzi is a thickness of an i'th slab within the group of slabs.

18. The computer-implemented method of claim 17, wherein slabs are placed until the start of a next slab being placed is within one meter of a light source or camera.

19. The computer-implemented method of claim 17, wherein slabs are placed until the start of a next slab being placed is within a user selected distance of a light source or camera.

20. The computer-implemented method of claim 17, wherein:
a first slab is placed starting at the camera, the first slab having a thickness of Δz₀;
one or more additional slabs are placed until a user selected maximum depth is reached, and further wherein:
each of the one or more additional slabs is placed adjacent to a previous slab; and
each of the additional slabs has a thickness of Δzₙ, wherein n is the number of the each additional slab relative to the first slab.
